(19) United States
(12) Patent Application Publication
(10) Pub. No.: US 2008/0065617 A1
(43) Pub. Date: Mar. 13, 2008

(54) Search entry system with query log autocomplete

(75) Inventors: Eric Paul Burke, Northville, MI (US); Duke Fan, San Jose, CA (US); Alan Wada, Mountain View, CA (US); Jawahar Malhotra, Cupertino, CA (US); Brian Coe, Scotts Valley, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/207,675

(22) Filed: Aug. 18, 2005

(51) Int. Cl. G06F 17/30

(52) U.S. Cl. 707/5

(57) ABSTRACT

A search entry system and method of search entry where the query terms can be autocompleted based on entries in a search history query log. A search system can include one or more entry modules, that can include a query window, configured to accept a search query. A query log can store one or more queries each query containing one or more query terms. Concurrent with entry of query terms in a query window, a query searcher can be configured to search one or more query logs for stored queries having the query terms contained anywhere within the query. An autocompletion module can be configured to process the results obtained from the query searcher and display or otherwise indicate to a user a selection of autocompletion options containing the current query terms.

### BACKGROUND OF THE DISCLOSURE

In a content retrieval system, a user makes a request, also referred to herein as a query, for content and receives content matching that request. The user can be a human user interacting with a user interface of a computer that processes the queries and/or forwards the queries to other computer systems. The user could also be another computer process or system that generates the query programmatically. In the latter instance, it is likely that the querying computer user will also programmatically process the results of the query, but it might instead be the case that a computer user makes a query and a human user is the ultimate recipient of the response, or even the opposite, where a human user makes a request and a computer user is the ultimate recipient of the response. A query can be in the form of a query string or other data structure, with or without context information and/or metadata such as user identification and/or user history.

Content retrieval systems are in common use. One common system in use today uses the network referred to as the Internet, a global internetwork of networks, wherein nodes of the network send queries to other nodes that might respond with content. One protocol usable for content requesting is the HyperText Transport Protocol (HTTP), wherein an HTTP client, such as a browser, makes a query for content referenced by a Uniform Resource Locator (URL) and an HTTP server responds to the queries by sending content specified by the URL. Of course, while this is a very common example, content retrieval is not so limited.

For example, networks other than the Internet might be used, such as token ring, WAP, overlay, point-to-point, proprietary networks, etc. Protocols other than HTTP might be used to query and transport content, such as SMTP, FTP, etc. and content might be specified by other than URLs. Portions of present disclosure are described with reference to the Internet, a global internetwork of networks in common usage today for a variety of applications, but it should be understood that references to the Internet can be substituted with references to variations of the basic concept of the Internet (e.g., intranets, virtual private networks, enclosed TCP/IP networks, etc.) as well as other forms of networks. It should also be understood that the present disclosure might operate entirely within one computer or one collection of computers, thus obviating the need for a network.

The content itself could be in many forms. For example, some content might be text, images, video, audio, animation, program code, data structures, formatted text, etc. For example, a user might request content that is a page having a news story (text) and an accompanying image, with links to other content (such as by formatting the content according to the HyperText Markup Language (HTML) in use at the time).

HTML is a common format used for pages or other content that is supplied from an HTTP server. HTML-formatted content might include links to other HTML content and a collection of content that references other content might be thought of as a document web, hence the name “World Wide Web” or “WWW” given to one example of a collection of HTML-formatted content. As that is a well-known construct, it is used in many examples herein, but it should be understood that unless otherwise specified, the concepts described by these examples are not limited to the WWW, HTML, HTTP, the Internet, etc.

A supplier of content might determine the interests of its users and provide relevant content, such as current news, sports, weather, search services, calendaring, messaging, information retrieval and the like. Content might be in the form of pages that are static (i.e., existing prior to a query for the page), dynamic (i.e., generated in response to a query) or partially static, partially dynamic. Thus, a news report about an event in a particular city might exist as a static page, but that same content might also be generated dynamically in response to a query, taking into account the context of the content and/or demographics of the user making the query.

As an example of a dynamically generated page, if the news report was being viewed by a user known to live in city in which the event is to occur, the resulting page might include information about how to drive to the location of the event or to purchase tickets, however if the user is known to live far from that city, the resulting page might include information about the weather in that remote city and how to purchase an airline ticket to that city.

A user may make a query for content by entering a destination address, such as a URL, of a location having the desired content. Additionally, a user may query content by linking to a site or page having the desired content and information.

A user may have no prior knowledge of the location or destination having desired content or a link to desired content. A user may search for desired content or search for links to desired content by accessing one or more locations operated by search providers and running one or more search applications made available by the search provider. For example, a user may access a known URL or destination made available by a search provider. A web browser application may provide a link to a location of such a search provider to facilitate searches.

A user may navigate to the search provider's site and enter one or more query terms in a user interface, which is typically a text entry box, and submit the query to the search application. The query terms can be text, characters, strings of characters, or some other input indicative of the query. Numerous search terms can be separated by a predetermined delimiter, such as a space character. The application provided by the search provider can then return one or more links to one or more locations having content related to the search query.

To further facilitate use of their services, some search providers now offer “search toolbar” add-ons for Web browser programs. A search toolbar typically provides a text box into which the user can type a query and a “Submit” button for submitting the query to the search provider's server. Once installed by the user, the search toolbar is generally visible no matter what page the user is viewing, enabling the user to enter a query at any time without first navigating to the search provider's Web site. Searches initiated via the toolbar can be processed in the same way as searches initiated at the provider's site; one difference is that the user is spared the step of navigating to the search provider's site. Typically, users might not know exactly the query that will achieve the desired results and prompting or other assistance in generating the query would be useful.

### BRIEF SUMMARY OF THE DISCLOSURE

A search entry system and method of search entry where the query terms can be autocompleted based on entries in a search history query log. A search system can include one or more entry modules, that can include a query window, configured to accept a search query. A query log can store one or more queries each query containing one or more query terms. Concurrent with entry of query terms in a query window, a query searcher can be configured to search one or more query logs for stored queries having the query terms contained anywhere within the query. An autocompletion module can be configured to process the results obtained from the query searcher and display or otherwise indicate to a user a selection of autocompletion options containing the current query terms.

Embodiments may include a method for generating a search query, including receiving at least a portion of a search entry, searching a query log for previously submitted queries matching the at least portion of the search entry, and generating an output having the at least one query for selection as the search query.

Embodiments may include a method for generating a search query, including receiving at least one character in a search entry window of a browser application, searching a query log based in part on the at least one character for entries having the at least one character located within the entry, formatting results from searching the query log to generate one or more formatted queries, and generating a display output having one or more formatted queries capable of selection as the search query.

Some embodiments include an apparatus for generating a search query, including a query input configured to receive a search term, a query log configured to store one or more previously submitted search queries, and an autocompletion module in communication with the query input and configured to search the query log for entries matching the search term in any position within the entry, and further configured to generate an output having one or more matching entries for selection as the search query.

Implementations may include an apparatus for generating a search query, including a client configured to execute a browser application providing a search query input, a query log associated with the browser application and configured to store one or more previously submitted queries, and a search client configured to operate in conjunction with the browser application and configured to search the query log for entries substantially matching a search entry entered into the search query input, the search client identifying entries for which the search query input substantially matches any position within the query log entry.

The benefits and advantages of the various methods and apparatus can be more fully appreciated by reference to the detailed description and accompanying drawings that follow.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of an embodiment of an information retrieval and communication network including a client system having query log autocompletion search entry.

FIG. 2 is a functional block diagram of an embodiment of an information retrieval and communication system including a search client having query log autocompletion search entry.

FIG. 3 is a functional block diagram of an embodiment of a search client having query log autocompletion search entry.

FIG. 4 is an example of a screen image of a graphical user interface illustrating a query input and autocompletion search results.

FIG. 5 is a flowchart of an embodiment of a method of query log based autocompletion search entry.

### DETAILED DESCRIPTION OF THE DISCLOSURE

With dynamic content available from a network of communication devices and a large number of users the same, or similar, queries might be expected to occur. Content available over the network may be dynamic due to the nature of the content, such as weather, news, or sports scores. Content available over the network may also be dynamic due to updating of available content sources, including revisions of existing content sources, additions of new relevant content sources, and deletion of previously available content sources.

A user initially searching for relevant content may need to tailor the query in order to retrieve search results that provide or link to relevant content. A user may revise query terms in a query in an attempt to cull search results for relevant content. The user may iteratively enter and submit queries, and the various queries may have common query terms to varying degrees as the query is optimized. A user may submit multiple similarly worded queries before deciding that a particular query provides the desired results.

Methods and apparatus are disclosed that enable autocompletion of query terms in a query based on queries stored in one or more query logs. A query log module can be configured to store one or more previously submitted search queries, each having one or more query terms. Upon entry of new query terms or partial query terms, such as part of a word, in an input interface, an autocompletion module can search the query log for queries that include the new query terms or partial query terms.

Autocompletion is a process of filling in, suggesting, hinting, or otherwise indicating to a user entering data that a computer system has indications of data that might be entered by the user. In the context of query entry, autocompletion of a query might involve accepting input from a user, identifying likely additional input based on what is entered so far, indicating the likely additional input, and typically giving the user an option to use the likely additional input or entering different input. The likely additional data may vary as the user provides additional input. Input can be in the form of text entry, option selection, and may include metadata not apparent to the user and/or not entered by the user.

The autocompletion module can be configured to search some or all of the partially entered query for each of the stored queries and determine if any portion of the stored query substantially matches the new query terms or partial query terms. The autocompletion module can rank the number of matching stored queries according to a predetermined ranking algorithm. The autocompletion module can then output the matching stored queries, in ranked order, to the user for possible selection. In one embodiment, the autocompletion module can display, or cause to be displayed, a menu or listing of matching stored queries in ranked order. The menu or listing of results can be referred to as autocompletion search entry terms because the terms can be generated and used to automatically complete a partial search entry input by a user.

The user can then have the option of selecting one of the displayed matching stored queries. A selected query from the list of matching stored queries can then replace the previously entered query terms in the input interface. The user can then submit the query or edit the query.

Alternatively, if the user does not select any of the matching stored queries, but instead continues to enter additional query terms or portions of query terms, the autocompletion module updates the list and ranking of the matching search queries in response to the updated query. The autocompletion module can continue to perform the autocompletion search and can continue to output results from the query log until there are no more matching entries in the query log, or until the user submits the query.

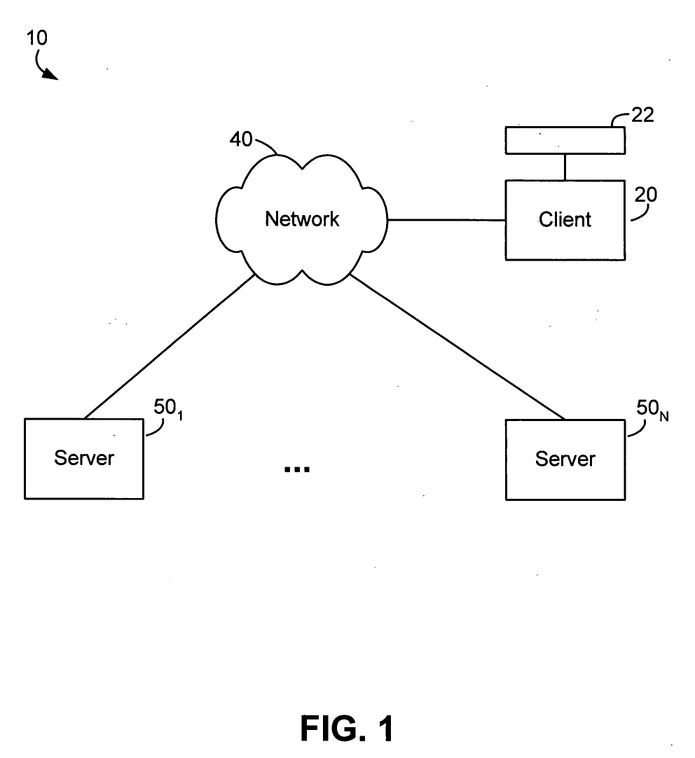

FIG. 1 illustrates a general overview of an embodiment of an information retrieval and communication network 10 including a client system 20 according to an embodiment of the present disclosure. In computer network 10, client system 20 is coupled through a network 40 to any number of server systems 50₁ to 50_{N}. The network 40 can be, for example, the Internet, or other communication network, such as a local area network (LAN), wide area network (WAN), and the like, or some other manner of interconnecting communication devices. As will be described herein, client system 20 is configured according to the present disclosure to communicate with any of server systems 50₁ to 50_{N}, e.g., to access, receive, retrieve and display media content and other information such as web pages.

Several elements in the system shown in FIG. 1 include conventional, well-known elements that need not be explained in detail here. For example, client system 20 could include a desktop personal computer, workstation, laptop, personal digital assistant (PDA), cell phone, or any WAP-enabled device or any other computing device capable of interfacing directly or indirectly to the network 40. Client system 20 typically runs a network interface application, which can be, for example, a browsing program such as Microsoft's Internet Explorer™ browser, Netscape Navigator™ browser, Mozilla™ browser, Opera™ browser, or a WAP-enabled browser in the case of a cell phone, PDA or other wireless device, or the like. The network interface application can allow a user of client system 20 to access, process and view information and pages available to it from server systems 50₁ to 50_{N} over Internet 40.

Client system 20 also typically includes one or more user interface devices 22, such as a keyboard, a mouse, touch screen, pen or the like, for interacting with a graphical user interface (GUI) provided by the browser on a display (e.g., monitor screen, LCD display, etc.), in conjunction with pages, forms and other information provided by server systems 50₁ to 50_{N} or other servers. Although the system is described in conjunction with the Internet, it should be understood that other networks can be used instead of or in addition to the Internet, such as an intranet, an extranet, a virtual private network (VPN), a non-TCP/IP based network, any LAN or WAN or the like.

According to one embodiment, client system 20 and all of its components are operator configurable using an application including computer code run using a central processing unit such as an Intel Pentium™ processor, AMD Athlon™ processor, or the like or multiple processors. Computer code for operating and configuring client system 20 to communicate, process and display data and media content as described herein is preferably downloaded and stored on a processor readable storage medium, such as a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of server systems 50₁ to 50_{N} to client system 20 over the Internet, or transmitted over any other network connection (e.g., extranet, VPN, LAN, or other conventional networks) using any communication medium and protocols (e.g., TCP/IP, HTTP, HTTPS, FTP, Ethernet, or other media and protocols).

It should be appreciated that computer code for implementing aspects of the present disclosure can be C, C++, HTML, XML, Java, JavaScript, etc. code, or any other suitable scripting language (e.g., VBScript), or any other suitable programming language that can be executed on client system 20 or compiled to execute on client system 20. In some embodiments, no code is downloaded to client system 20, and needed code is executed by a server, or code already present at client system 20 is executed.

The client 20 can include code configured to operate as a browser application capable of interfacing with one or more of the server systems 50₁ to 50_{N} to search for and retrieve content. The client 20 can be configured to use the browser application to search the one or more server systems 50₁ to 50_{N} for relevant content or links to relevant content. A user, or in general any searcher, at the client 20 can, for example, use the one or more user interface devices 22 to input a query having one or more query terms. The user can then submit the query to one or more server systems 50₁ to 50_{N} where a search process can be executed.

The example of a search process as described herein can be modeled by a searcher presenting to a search system a query and receiving a response (search results) indicating the one or more “hits” found. A query can be in the form of query terms or key words (e.g., searching for the latest football scores with a query string “football games scores recent”), structured query statements (SQL, Boolean expressions, regular expressions, etc.), by selecting terms from choice lists, following links or a number of other methods currently in use or obvious to one of skill in the art upon review of current literature and/or the present disclosure.

When a query is received by a search system, it processes the search and returns one or more “hits”, where a “hit” is the atomic unit handled by the search system. For example, where the search system manages a structured database, the hits are records from the structured database. Where the search system manages documents, such as text documents, image and text documents, image documents, HTML documents, PDF documents, or the like, the atomic unit is the document. It should be understood that the present disclosure is not limited to any particular atomic unit. Furthermore, a structured database is not required.

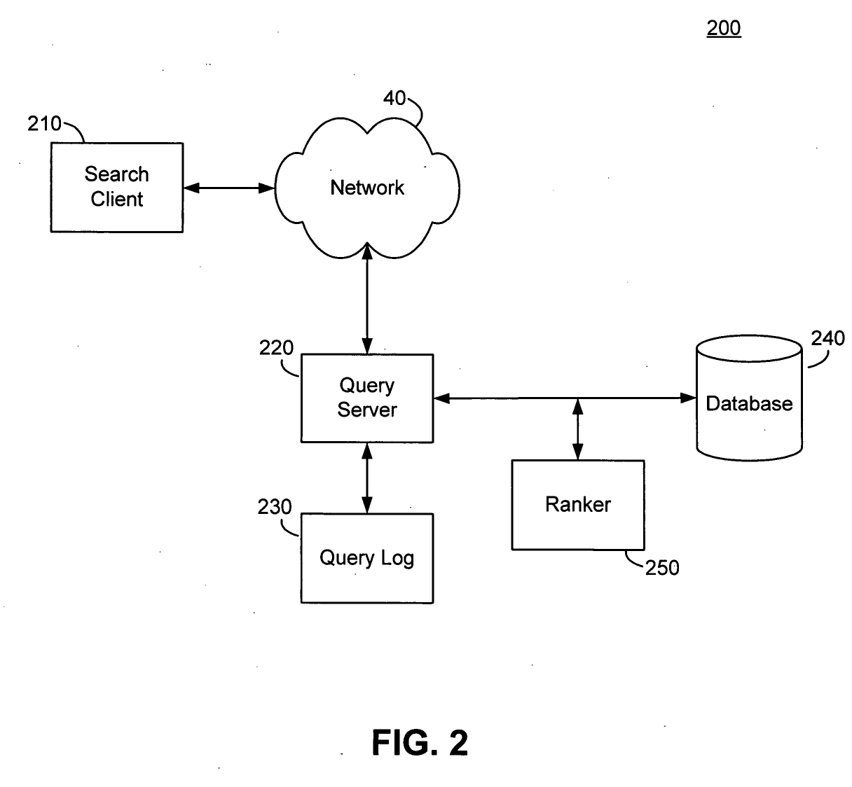

FIG. 2 is a functional block diagram of an embodiment of an information retrieval and communication system 200 including a search client 210 having query log autocompletion search entry. The search client 210 can form a portion of the client 20 of FIG. 1. In one embodiment, the search client 210 can be an application running in the client of FIG. 1, and can be configured to run within or in conjunction with another application, such as a browser.

The communication system 200 can include a search client 210 coupled to a network 40, which can be the Internet. A query server 220 can be coupled to the network 220 and can be configured to perform network searches based on received search queries. One or more search provider may configure and provide access to the query server 220. Although only one search client 220 is shown as being connected to the network 40, it is understood that a typical communication system 200 can have a plurality of search clients 220 simultaneously coupled to the network 40 and simultaneously, or otherwise concurrently in communication with the query server 220. Similarly, although FIG. 2 only depicts a single query server 220, multiple query servers 220 can be coupled to the network 40 and can be operated by one or more search providers.

The search client 210 can include, for example, a software program resident on a client 20 or downloaded to the client 20 from a provider, such as from a server 50 coupled to the network 40. The search client 210 can include a library file, such as a Dynamic Link Library (DLL) on the client 20 that creates one or more shells within a browser. Each shell can provide information or functionality loaded, for example, as an ActiveX control or plug-in. The shell can represent the search client 210 as a toolbar within a browser interface. The functionality of the search client 210 may be updated or changed by receiving update information communicated by an appropriate server.

The search client 210 can be configured to submit one or more search queries over the network 40 to the query server 220. The query server 220 can be configured to store or otherwise capture the query in an associated query log 230. In the system shown in FIG. 2, the query server 220 can be configured to communicate queries to the query log from one or more search clients 210 coupled to the network 40.

The queries stored in the query log 230 can be used for a variety of functions. For example, the query server 220 may, upon receiving a query, examine the query log 220 to determine if an identical query has recently been processed by the query server 220. If so, the query server 220 may have access to the search results without performing an additional search. Additionally, the contents of the query log can be shared with a ranker 250 configured to collect statistics relating to popular and repeated query terms or search queries for the purposes of generating or updating a search result ranking algorithm.

The query server 220 can also be configured to access and search a database 240 for one or more records from the database 240 matching the search criteria. The query server 220 can be configured to use a predetermined search algorithm to identify the records that are substantially similar in semantics or context to the query and that can be considered matching or otherwise relevant to the query.

The database 240 can be generated using, for example, one or more web crawlers that systematically attempt to address and access all available content on the network 40 and catalog the results in a repository in the database 240.

The query server 220 can return query results to a ranker 250 that is configured to order the one or more query results into a ranked order according to a predetermined ranking algorithm. The ranking algorithms used by the various search providers may be proprietary and maintained confidentially in order to eliminate the possibility of content providers manipulating the rankings to artificially generate traffic to the site maintained by the content providers.

The ranker 250 can return the search results in ranked order to the query server 220. The query server 220 can then be configured to format and return a portion or all of the ranked search results to the search client 210 via the network 40. The search client 210 can then display or otherwise output the search results to the user.

As discussed above, the search client 220 may be configured to submit queries that are similar or even identical to previously submitted searches. To facilitate the search entry process, the search client 210 can implement an autocompletion process that can generate one or more autocompletion selections based on the query terms, or portions of query terms entered within an input interface. The search client 210 can also be configured to generate the one or more autocompletion selections based in part on the contents of one or more query logs, which may include the query log 230 associated with the query server 230 and/or local query logs (not shown) that are maintained local to the search client 210.

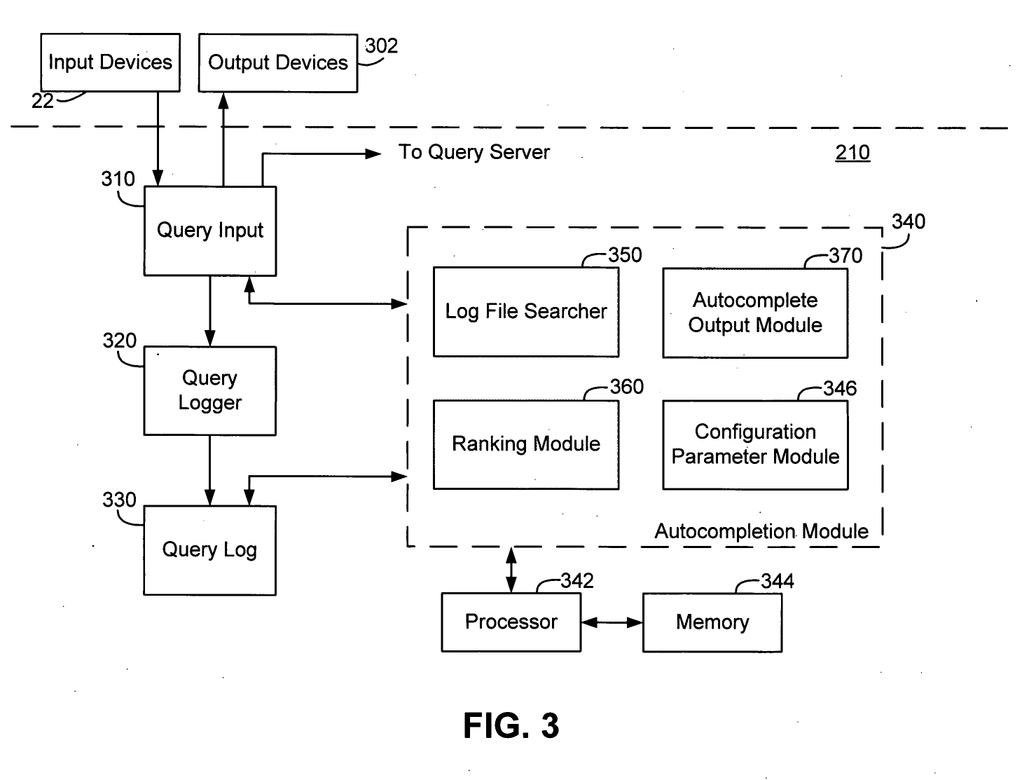

FIG. 3 is a functional block diagram of an embodiment of a search client 210 having query log autocompletion search entry. The search client 210 of FIG. 3 can be the search client of FIG. 2 and can be configured to interface in a networked communication system, such as the system of FIG. 1.

The search client 210 can include a query input 310 configured to receive a query that can include one or more query terms. The query input 310 can be configured to receive a query from one or more user interface devices 22. In one embodiment, the user interface devices 22 can include a keyboard, a mouse, touch screen, pen or the like, for interacting with a graphical user interface (GUI) provided by the browser on a display. In another embodiment, the user interface devices 22 can include a register, port, coupler, or connector configured to interface with another electronic device and configured to receive an electronic representation of the query and couple the query to the query input 310.

The contents of the query input 310 can be coupled to one or more output devices 302, such as a display. Such a configuration can be advantageous when the search client 210 is configured to provide a query input 310 configured to operate with a graphical browser interface. In one embodiment, the contents of the query input 310 can be displayed on a display in the form of a text box.

The user interface devices 22 and output devices 302 typically are part of a user interface and do not form a part of the search client 210, and may be external to, and interface with, the search client 210. Typically, the user interface devices 22 and output devices 302 are local to the search client 210 but one or more may also be configured to be remote from the search client 210.

For example, a user can use a keyboard to enter a query into the query input 310 and can submit the query. A query logger 320 can log the query into a query log 330 when the query is submitted to a query server (not shown). Thus, the query log 330 can be configured to store one or more previously submitted queries.

The query logger 320 in the search client 210 can also be configured to log queries and associated search types that are entered and submitted by the user, via the input devices, to a search input page distinct from the search client 210. For example, the user can use an Internet browser to navigate to a particular site of a search provider and enter a query at the interface provided by the search provider. The search client 210 can capture or otherwise trap queries submitted at search provider interfaces and can store these captured queries in the query log 330.

The query logger 320 operating within the search client 210 can, for example, analyze tags included in pages or can analyze particular predetermined addresses, such as URL patterns, identifying provider interfaces. The query logger 320 can be configured to capture or otherwise trap the query when the query logger 320 detects an identified tag or URL pattern. The tags and URL patterns can be configured within the configuration parameter module 346 and can be updated to change or update the tags and/or URL patterns that identify search provider interfaces.

The query log 330 can be associated with a particular client, for example, a local computer on which the search client 210 is resident. In another embodiment, the query log 330 can be unique to a particular user of the client. The search client 210 can be unique to specific users. Each user can have search client 210 functionality that is unique to that user. The user can be associated with a particular account that can be local to the client or that can be administered at a remote server. The user can log into the corresponding account and the search client 210 can be configured according to the client preferences.

In one embodiment, the user account can be local to the client and the client can provide access to the unique query log 330 corresponding to the user when the account is accessed. Alternatively, the user account can be configured remote from the client, for example, a remote server. The user can access or otherwise log into the account and the server can communicate commands to the search client 210 to indicate the particular search history 330 corresponding to the user.

The search client 210 can also include an autocompletion module 340 that is in communication with the query input 310. The autocompletion module 340 can be configured to operate in conjunction with the query input 310 prior to submission of the query to the query server. The autocompletion module 340 can be configured to provide one or more autocompletion selections to the user, based on terms entered into the query input 310. The autocompletion module 340 can be coupled to a processor 342 that is in communication with memory 344. Some or all of the processes and functions performed by the autocompletion module 340 can be performed by the processor 342 in conjunction with processor usable instructions stored in memory 344.

The autocompletion module 340 can be coupled to the query input 310 and the query log. The autocompletion module 340 can include a configuration parameter module 346, a log file searcher 350, ranking module 360, and autocomplete output module 370.

The autocompletion module 340 can include a configuration parameter module 346 that can help define the functionality of the search client 210. The configuration parameter module 346 can define, for example, a catalog of icons, colors, or audio sounds associated with each query, a format of a query string, a number of entries to display from a client query log, and a number of entries to store in the query log 330 before wrapping. For example, the query log 330 may be configured as a First In First Out (FIFO) buffer, and the depth of the FIFO queue can be configured by a parameter within the configuration parameter module 346.

The parameters stored in the configuration parameter module 346 can be static or can be dynamic. For example, the search client 210 can be updated or changed by receiving update information communicated by an appropriate server. The search client 210 can periodically access a server to see if update information is available and can download update information from the server if it is available. Alternatively, the server may communicate a notification of the availability of update information to the search client 210. The search client may download or otherwise receive the update information from the server by responding to the notification from the server.

The configuration parameter module 346 may also be configured to allow the user to access and edit the query log 330. In the embodiment where the query log 330 is unique to the user, the configuration parameter module 346 can be configured to allow the user to display and edit the particular query log 330 corresponding to the user, and may exclude access to the query logs 330 corresponding to other users. The configuration parameter module 346 can, for example, allow the user to manually delete one or more entries within the query log 330. The configuration parameter module 346 can also be configured to allow the user to clear or otherwise delete the entire contents of the query log 330.

The log file searcher 350 can be configured to monitor the query input 310 and search the contents of the query log 330 in response to entries or updates of the query input 310. For example, if the query input 310 represents the contents of a text entry box, the user or searcher can input a query in the form of a series of individual characters, such as the characters typically available on a keyboard.

In one embodiment, the log file searcher 350 can access and search the query log 330 in response to each character entered into the query input 310. In another embodiment, the log file searcher 350 can access and search the query log 330 after a predetermined number of characters are entered into the query input 310. The predetermined number can be, for example, 2, 3, 4, 5 or some other number. In still another embodiment, the log file searcher 350 can access and search the query log 330 after entry of any one of a predetermined subset of possible characters. For example, the log file searcher 350 can be configured to search the query log 330 after a character, such as a space character or other white space is entered into the query input 310. Other log file searcher 350 embodiments can use other criteria, or combinations of criteria for initiating a search.

A log file searcher 350 can thus be configured to initiate a search of the query log 330 based on a variety of criteria. Once the search criteria have been met, the log file searcher 350 can be configured to search the query log 330 for one or more entries that match the contents of the query input 310. The log file searcher 350 can use a set of matching criteria to determine if the contents of the query input 310 match any of the entries in the query log 330.

For example, in one embodiment, the log file searcher 350 can be configured to return as possible matches those entries that match exactly the contents of the query input 310. In another embodiment, the log file searcher 350 can return as a possible match those query log 330 entries that have at least a portion that exactly matches the contents of the query input 310. The matching entries can be limited to those entries whose initial characters match those of the query input 310. Alternatively, the matching entries may be any query log 330 entries having a character string exactly matching that of the query input 310, regardless of position within the query log 330 entries.

In still other embodiments, the log file searcher 350 can be configured to return as possible matches, those entries within the query log 330 that match the contents of the query input 310 to some degree, or within an error distance suitably defined. For example, those query log 330 entries having one character different from the characters in the query input 310 may be considered a match. In other embodiments, the error distance may be two characters or more. The error distance may be dynamic and may be based on the length of the contents of the query input 310. For example, the error distance can be a percentage of the length of the query input 310 contents, rounded down to the nearest integer. Of course, the log file searcher 350 can be configured to implement other matching criteria or combinations of matching criteria.

The log file searcher 350 can be configured to return the results of the search of the query log 330 to a ranking module 360 that can be configured to rank the log search results according to a predetermined ranking algorithm. The ranking module 360 can, for example, rank the search results in a hierarchical order that is based on age of the entries in the query log 330, with more recent entries being ranked higher than older entries. The ranking module 360 operates on the results from the log file searcher 350, that can be distinct from the results of a search of the corpus. In another embodiment, the ranking module 360 can be configured to order the results in alphabetical order. In still other embodiments, the ranking module 360 can be configured to order the query log 330 search results according to some other algorithm. For example, the ranking module 360 may rank results according to a metric that characterizes how much a particular result differs from the query input 310 contents. For example, those query log 330 entries that exactly match the query input 310 can be ranked the highest, and other query log search results can be ranked lower depending on the number and position of character differences. Still other ranking embodiments may rank the query log search results in an order of relevance, using a context based ranking.

After the ranking module 360 has completed the ranking process, the ranking module 360 can communicate the ranked results, or an indicator, such as a pointer to the ranked results, to an autocomplete output module 370. The autocomplete output module 370 can further filter the ranked results and format them for output on one or more of the output devices 302. In one embodiment, the autocomplete output module 370 can filter the results to be less than or equal to a predetermined maximum number of displayed results. The autocomplete output module 370 can then format the results for display in, for example, a popup window or scrollable menu that is displayed on an output device 302. The popup window or scrollable menu can be positioned, fore example near, or contiguous with, the displayed query input window. If only one search result exists, the autocomplete output module 370 can be configured to autocomplete the entry in the query input 310 with the search result.

The search client 210 can be configured to allow a user to select one of the displayed autocompletion results or accept the autocompleted query. The search client 210 can then allow the user to continue to enter query terms or otherwise edit the query input 310.

If the user does not select one of the autocomplete results and continues to enter additional characters, or if the user selects one of the autocomplete search results but edits or continues to enter additional characters, the process performed by the autocompletion module 340 is repeated. The process can continue to be updated until the user commands the search client 210 to submit the query.

The search client 210 of FIG. 3 is described as accessing and searching a query log 330 that is local to the search client 210. In other embodiments, the log file searcher 350 can be configured to search one or more query logs that may be external, or otherwise remote from, the search client 210. For example, the log file searcher 350 can be configured to search a local query log 330 as well as a remote query log for which a destination address is known. The remote query log can be, for example, a query log associated with a query server, such as the query server shown in FIG. 2.

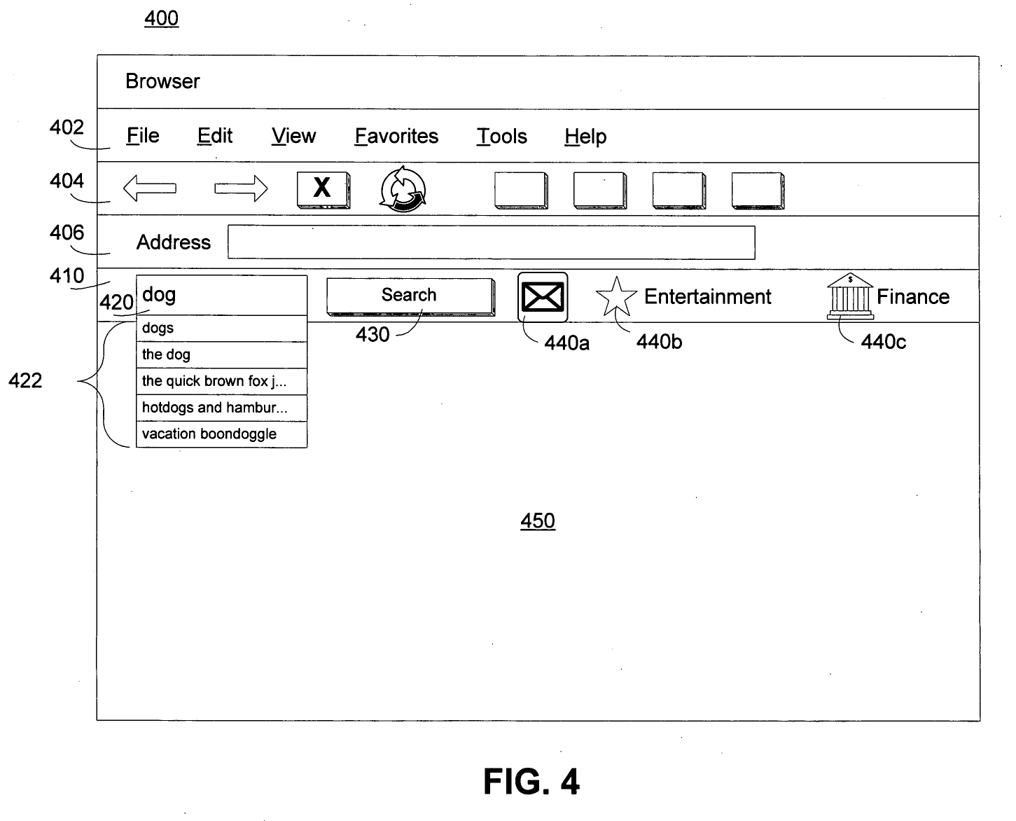

FIG. 4 is an example of a graphical user interface (GUI) 400 illustrating a query input window 410 and autocompletion search results 412. The GUI 400 is shown configured as a typical browser interface window. However, the methods and apparatus disclosed herein are not limited to applicability in a browser interface.

The GUI 400 can be configured as a window or graphical interface having one or more control portions 402 and 404, each control portion including one or more buttons or objects that can be selected to provide a corresponding control. The GUI 400 can include an address entry window 406 configured to accept user entry of a destination address.

The GUI 400 can also include a toolbar 410 having a query input window 420 and one or more control buttons or pull down menus 440a-440c that can be accessed by the user. The GUI 400 can also include a content window 450 or portion configured to display content that can be, for example, information displayed as a result of a search.

The user can use an associated input device to enter one or more query terms in the query input window 420. The query input window 420 can correspond to an output of the contents of a query input, such as the query input of FIG. 3. In the example shown in FIG. 4, the query input window 420 displays the query “dog” that may have been entered by a user operating a keyboard. The autocompletion results 422 are displayed as a plurality of selections arranged in a scrollable window that is positioned near the query input window 420.

The autocompletion results can be obtained by searching a query log. For example, let the query log include the terms {“dogs”, “the quick brown fox jumped over the lazy dog”, “the dog”, “cats are cool”, “hotdogs and hamburgers”, “vacation boondoggle”}. The autocompletion module can search the query log and format the search results for display. The autocompletion module can return those query log entries that match the query input window 420, as determined by a predetermined search algorithm. For example, in one embodiment, all query log entries containing the term “dog” regardless of location in the query can be determined to be a match.

In the example shown in FIG. 4, the displayed autocompletion results can include the set {“dogs”, “the dog”, “the quick brown fox j . . . ”, “hotdogs and hambur . . . ”, “vacation boondoggle”}. The autocomplete output module may truncate the search results to a predetermined length. Thus, the third autocompletion result appears as “the quick brown fox j . . . ” and does not even include the search term in the output. However, the inclusion of an ellipses can indicate to the user that the result was truncated for display.

The search results can be ranked according to an algorithm executed by a ranking module. In some embodiments, the final two entries {“hotdogs and hamburgers”, “vacation boondoggle”} may be omitted from the search results if the log file searcher executes a context sensitive search on the query log.

The GUI 400 running on a search client can allow the user to select one of the autocompletion results. If an autocompletion result is selected, the result appears in the query input window 420. The user can then choose to submit the query or edit the query.

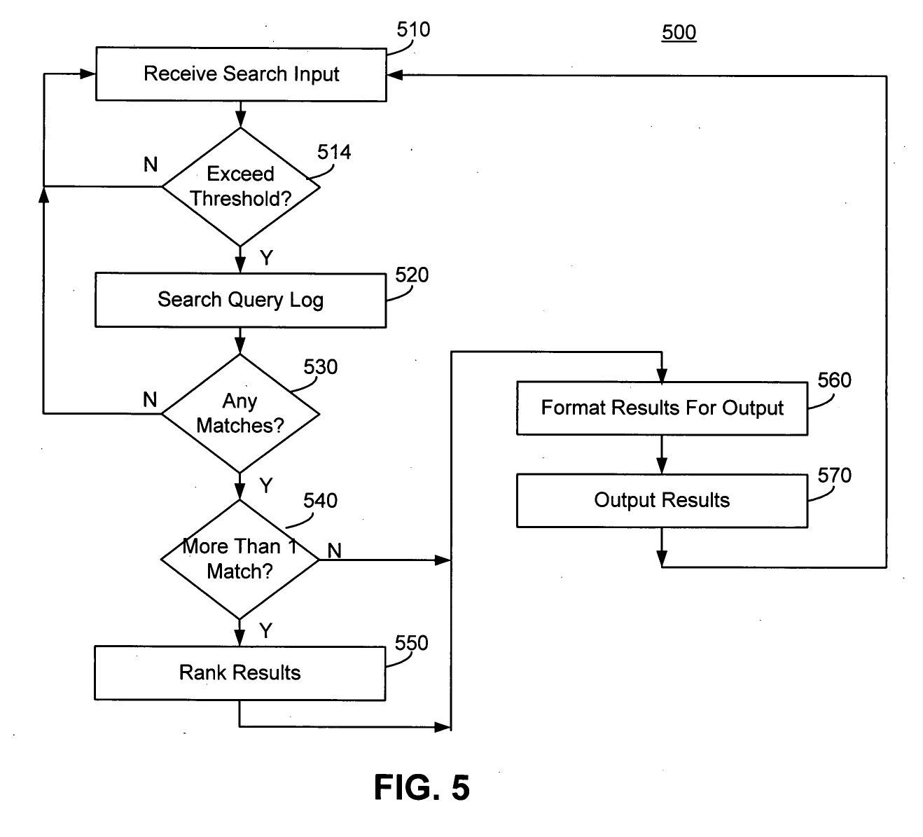

FIG. 5 is a flowchart of an embodiment of a method 500 of query log based autocompletion search entry. The method 500 can be performed, for example, by the client 20 of FIG. 1 or the search client 210 of FIG. 3, in conjunction with one or more input and output devices. The method 500 can be, for example, embodied as one or more processor usable instructions stored in one or more storage devices within the search client. The processor can execute the instructions to perform the method 500 in conjunction with external input and output devices.

The method 500 begins at block 510 where the search client receives search input. As noted before, the search input can be received in a text window within a browser application. The search input can be portions or all of a query, and can be as little as a single character.

After receiving search input, which may be one or more characters entered into a text window, the search client proceeds to decision block 514 and determines if the amount of search input exceeds a minimum threshold. For example, in embodiments where the search client updates after each character is entered into the text window, the entry of a single character or two characters may be insufficient for the search client to return meaningful autocompletion results. Thus, the search client might not attempt to search for autocompletion results until the amount of input exceeds a minimum threshold.

If, at decision block 514, the search client determines that the minimum input threshold is not exceeded, the search client returns to block 510 to receive additional search input. If, at decision block 514, the search client determines that the amount of search input exceeds the threshold, the search client proceeds to block 520 and performs a search of one or more query logs. The query logs can be local to the search client, remote from the search client, or at a combination of local and remote locations. After searching the query logs, the search client proceeds to decision block 530 to determine if the search resulted in any matches, or hits, to the query terms.

If the search client determines that no matches occurred, the search client can return to block 510 to receive additional search input. Alternatively, the search client can terminate the autocompletion method 500.

If, at decision block 530 the search client determines that at least one match exists, the search client proceeds to decision block 540. At decision block 540, the search client determines if more than one math resulted from the search of the query logs.

If more than one match exists, the search client proceeds to block 550 and ranks the results, for example, using a predetermined ranking algorithm. The search client then proceeds to block 560 to format the search results for output. If, at decision block 540, the search client determines that only one match was uncovered, the search client can omit the ranking process and merely proceeds to block 560 to format the search result for output.

The search client can be configured to format the search results for output based on the number of search results. If a single search result is generated, the search client may format the search result and display the search result in the search input text window. The portion of the search term representing the autocompletion can be highlighted or otherwise identified as resulting from the execution of the autocompletion method 500.

If more than one search result is generated, the search client can be configured to generate an output based on the order of search results generated in a ranking module. Additionally, the search client may format the number of results that are output to omit from the output the search results that are ranked lower than a predetermined threshold. For example, to minimize the amount of clutter output to a GUI display, the search client may limit the number of autocompletion search results to an easily displayed number of results, such as ten results. Thus, the search client may select the ten most relevant results. Of course other embodiments may enable the display of more or fewer autocompletion search results.

Additionally, the search client may format the length of the autocompletion results. For example, prior search queries that are stored in the query log and that match the search input may be long query strings having numerous characters. The search client may truncate the query for the purposes of display. The search client will typically not truncate the actual query, rather, the display associated with the query is truncated as part of the formatting. If a user selects the truncated query from the output, the complete query is returned to the input text window.

After formatting the search results in block 560, the search client proceeds to block 570 and outputs the formatted results. In one embodiment, a single result can be displayed in the search entry text window with the autocompletion portions of the search entry highlighted or otherwise identified as generated by the autocompletion process. In another embodiment, multiple autocompletion search results can be displayed in a drop down menu positioned near, or contiguous with, the location of the search entry text window. In still another embodiment, multiple autocompletion search results can be displayed in a scrollable window positioned near, or contiguous with, the location of the search entry text window. Other embodiments may output the search results in other manners which can use a combination of the above described outputs.

After outputting the autocompletion search results, the search client can proceed back to block 510 to await additional search input. The user can select one of the autocompletion search results, continue to enter search entry terms, or submit the present search query without selecting a search result. If the user selects one of the autocompletion search entries, the search client can be configured to populate the query into the search entry text window. The user can then submit the query or continue to edit the search query.

Methods and apparatus for autocompletion of search entry using information stored in a query log are described above. The methods and apparatus generate autocompletion options that are based on the present search entry terms. The autocompletion options generated from the query log entries do not necessarily begin with the present search entry terms. Instead, the search entry terms can occur in any position within the query log entries.

The methods and apparatus allow a user to quickly identify previous queries that may be related to the present query to facilitate search entry and resubmission or editing of the previously submitted query.

The various illustrative logical blocks, modules, and circuits described in connection with the embodiments disclosed herein may be implemented or performed with a general purpose processor, a digital signal processor (DSP), a Reduced Instruction Set Computer (RISC) processor, an application specific integrated circuit (ASIC), a field programmable gate array (FPGA) or other programmable logic device, discrete gate or transistor logic, discrete hardware components, or any combination thereof designed to perform the functions described herein. A processor may be implemented as a combination of computing devices, for example, a combination of a DSP and a microprocessor, a plurality of microprocessors, one or more microprocessors in conjunction with a DSP core, or any other such configuration.

A software module may reside in RAM memory, flash memory, non-volatile memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. In a computer system wherein users submit search queries via a user interface to a search engine and receive search results corresponding to searches of a search corpus according to the submitted search queries, wherein representations of the submitted queries are logged to a query log, a method of prompting a user during entry of a search query comprising:
receiving at least a portion of a current search entry at the computer system;
searching the query log for previously submitted search query representations corresponding to previous search queries matching the current search query;
generating an output, usable for display to the user, of indications of the matching previous search queries; and
presenting the user with a display allowing the user to select at least one of the indicated matching previous search queries for use as all of part of the current search query.

2. The method of claim 1, wherein matching the current search query comprises matching exactly the current search query.

3. The method of claim 1, further comprising:
determining if the at least portion of the current search entry exceeds a predetermined threshold of characters; and
wherein searching the query log comprises searching the query log if the at least portion of the current search entry exceeds the predetermined threshold of characters.

4. The method of claim 1, further comprising formatting the matching previous search queries from the query log for output.

5. The method of claim 4, wherein formatting the matching previous search queries comprises truncating each of the matching previous search queries to have a length that is less than a predetermined threshold.

6. The method of claim 4, wherein formatting the matching previous search queries comprises selecting a predetermined number of queries from the matching previous search queries.

7. The method of claim 4, wherein formatting the matching previous search queries comprises formatting a display output.

8. The method of claim 1, further comprising ranking the matching previous search queries.

9. The method of claim 8, wherein ranking the matching previous search queries comprises ordering the matching previous search queries in alphabetical order.

10. The method of claim 8, wherein ranking the matching previous search queries comprises ordering the matching previous search queries in an order of relevance.

11. The method of claim 8, wherein ranking the matching previous search queries comprises ordering the matching previous search queries in an order based on an age of each query from the matching previous search queries.

12. The method of claim 1, wherein receiving the at least portion of the current search entry comprises receiving a character entry.

13. The method of claim 1, wherein receiving the at least portion of the current search entry comprises receiving an entry in a text entry window of a browser application.

14. The method of claim 1, wherein searching the query log comprises searching the query log for previously submitted search query representations having exactly the at least portion of search entry in any position within the previously submitted search query representations.

15. The method of claim 1, wherein searching the query log comprises searching the query log for previously submitted search query representations matching, within any position within the previously submitted search query representations, the at least portion of search entry within a predetermined error distance.

16. The method of claim 1, wherein searching the query log comprises searching the query log for previously submitted search query representations matching, within any position within the previously submitted search query representations, the at least portion of search entry with no more than one character difference.

17. The method of claim 1, wherein presenting the user with the display comprises populating a search entry window in the user interface with a query from the matching previous search queries.

18. The method of claim 1, wherein presenting the user with the display comprises generating a drop down menu display having at least one query from the matching previous search queries.

19. The method of claim 1, wherein the portion of the current search entry comprises at least one character in a search entry window of a browser application, and further comprising formatting results from searching the query log to generate one or more formatted queries.

20. In a computer system wherein users submit search queries via a user interface to a search engine and receive search results corresponding to searches of a search corpus according to the submitted search queries, wherein representations of the submitted queries are logged to a query log, an apparatus for prompting a user during entry of a search query, the apparatus comprising:
a query input configured to receive at least a portion of a current search entry from the user interface;
a query log configured to store one or more previously submitted search query representations corresponding to previous search queries; and
an autocompletion module in communication with the query input and configured to search the query log for previously submitted search query representations corresponding to previous search queries matching the current search query, and further configured to generate an output, usable for display to the user, of indications of the matching previous search queries, and communicating the output to a display allowing the user to select at least one of the indicated matching previous search queries for use as all of part of the current search query.

21. The apparatus of claim 20, wherein the autocompletion module comprises:
a log file searcher configured to search the query log for previous search queries matching the search term in any position within the entry; and
a ranking module in communication with the log file searcher and configured to rank the matching previous search queries and generate ranked entries.

22. The apparatus of claim 21, wherein the autocompletion module further comprises an autocomplete output module configured to format and display at least a portion of the ranked entries.

23. The apparatus of claim 21, wherein the log file searcher determines a match based on the search term and at least a portion of a query log entry differing by less than a predetermined error distance.

24. The apparatus of claim 21, wherein the log file searcher determines a match based on the search term matching exactly at least a portion of a query log entry.

25. The apparatus of claim 20, wherein the search term comprises at least one text character.

26. The apparatus of claim 20, wherein the output comprises a display list including a truncated portion of the previous search queries matching the search term.

27. An apparatus for generating a search query, the apparatus comprising:
a client configured to execute a browser application providing a search query input;
a query log associated with the browser application and configured to store one or more previously submitted queries; and
a search client configured to operate in conjunction with the browser application and configured to search the query log for entries substantially matching a search entry entered into the search query input, the search client identifying entries for which the search query input substantially matches any position within the query log entry.

28. An apparatus for generating a search query, the apparatus comprising:
means for receiving a search term;
means for storing one or more previously submitted search queries;
means for searching the means for storing for one or more search queries matching the search term at any position within the search queries; and
means for providing at least one matching query for selection as the search query.

29. A computer readable medium having stored thereon instructions configured to cause generation of a prompt to a user during entry of a search query, the instructions comprising:
program code for receiving at least a portion of a current search entry at the computer system;
program code for searching the query log for previously submitted search query representations corresponding to previous search queries matching the current search query;
program code for generating an output, usable for display to the user, of indications of the matching previous search queries; and
program code for presenting the user with a display allowing the user to select at least one of the indicated matching previous search queries for use as all of part of the current search query.
